(19) United States
(12) Patent Application Publication
(10) Pub. No.: US 2025/0154796 A1
(43) Pub. Date: May 15, 2025

(54) Electronic Locking Cylinder

(71) Applicant: Salto Systems, S.L., Oiartzun (ES)

(72) Inventors: Ander Muñoz Laguardia, Oiartzun (ES); Javier Lecaroz Amunarriz, Oiartzun (ES)

(21) Appl. No.: 18/838,468

(22) PCT Filed: Feb. 14, 2023
(86) PCT No.: PCT/ES2023/070079

§ 371 Date: Aug. 14, 2024

(30) Foreign Application Priority Data
Feb. 15, 2022 (ES) P202230117

(51) Int. Cl. E05B 47/06; E05B 15/00; E05B 47/00

(52) U.S. Cl. CPC E05B 47/0619; E05B 15/006; E05B 47/0012; E05B 2047/0028; E05B 2047/0088

(57) ABSTRACT

An electronic cylinder that can be actuated by an electronic key, wherein said electronic cylinder includes a stator body, a rotor, a motor that can be actuated by the electronic key, a clutch mechanism configured to lock and unlock the rotation of the rotor with respect to the stator body by means of the actuation of the motor, and a system for detecting rotation of the rotor with respect to the stator body, said system being configured to deactivate the motor when the rotor rotates with respect to the stator body. To this end, the clutch mechanism includes two locking balls which are elements that move radially inside the cylinder, to lock and unlock the rotation of the rotor) with respect to the stator body, said rotation of the rotor being carried out by the electronic key.

### CROSS-REFERENCE TO RELATED APPLICATIONS

This application is the United States national phase of International Application No. PCT/ES2023/070079 filed Feb. 14, 2023, and claims priority to Spanish Patent Application No. P202230117 filed Feb. 15, 2022, the disclosures of which are hereby incorporated by reference in their entireties.

### BACKGROUND OF THE INVENTION

### Field of the Invention

The present invention consists of an electronic cylinder that can be unlocked and opened by means of an electronic key. Said cylinder comprises a clutch mechanism that can be actuated electronically, the objective of which is to provide a lock on the rotor of the cylinder, which makes it possible to provide a safe and robust lock against possible attacks for a door or access with an electronic locking means, as well as a system for detecting rotation of the rotor with respect to the stator body that allows the motor to be deactivated when the rotor rotates with respect to the stator body, optimally managing energy consumption.

The invention falls within the locksmith sector and more specifically in the sector of electronic or electromechanical cylinders for access control systems.

### Description of Related Art

In access control systems today, the use of electronic cylinders is becoming more common due to their versatility, security, as well as the capacity for configurations that they have, unlike cylinders that operate on a purely mechanical basis. Configurations such as limiting said accesses based on the needs or preferences of the user, allowing openings at certain times, as well as obtaining information on the openings or opening attempts made.

On the market of electronic cylinders, there are those that have electrical charge storage means inside same, such as batteries, as well as the control system, which allows independent use of said cylinder, without requiring external wired connections.

In addition to these systems, cylinders that do not incorporate a battery or control system inside same, or that do not have fixed wired connections but rather are powered electrically and controlled by means of management systems located in the key, can also be found on the market. That is, cylinders that, due to their characteristics, are intended to be installed in accesses with a difficult electrical connection, or that are subject to changes in temperature or weather that can affect the operation of a fixed battery, as well as its replacement.

In this way, the invention is focused on these last types of electronic cylinders.

Cylinders of this type, which do not have a battery, are used especially in installations which, due to their location or the weather to which they are going to be subjected, require them to be robust, to incorporate as little electronics as possible and to require little maintenance.

Some examples of use of cylinders of this type can be to control access to electrical substations located in isolated places, to outdoor areas where materials, large warehouses, or simply, instruments or machinery of great value can be located.

In installations of this type, as a result of the electronic cylinders, it is possible to manage the permissions of who can or cannot access them, configuring an access key with a code through an electronic device. Likewise, these permissions can be temporary, that is, they can only be used for a certain time, and on the other hand, they also allow entry and exit control controlled by a management system. For these cylinders, it will only be necessary to have a key in which the control systems are integrated, as well as a battery that can power the cylinder to perform the unlocking or opening operation.

However, the problem presented by these cylinders is twofold. On the one hand, the safety of the cylinder must be guaranteed so that it provides correct operation, that is, it does not fail when it opens and closes, and so that it offers resistance to tampering.

On the other hand, the consumption of the motor of the cylinder must be as low as possible so that it is efficient for the user, preventing the latter from having to charge or change the key battery every short period of time.

### SUMMARY OF THE INVENTION

The present invention consists of an electronic cylinder actionable by an electronic key, that can be inserted in the electronic cylinder, wherein said electronic cylinder comprises a stator body, a rotor configured to rotate with respect to the stator body, a motor actionable, i.e. that can be actuated, by the electronic key, a clutch mechanism configured to lock and unlock the rotation of the rotor with respect to the stator body by the actuation of the motor; and a system for detecting rotation of the rotor with respect to the stator body, said system being configured to deactivate the motor when the rotor rotates with respect to the stator body.

The system for detecting rotation of the rotor with respect to the stator body can be configured to deactivate the motor when the rotor rotates, thereby reducing energy consumption.

The system for detecting rotation of the rotor can comprise:
a position detection magnet located in the stator body;
a field transmitter located in the rotor; and
a magnetic sensor located in the rotor, configured to detect the magnetic field emitted by the position detection magnet and channelled to the magnetic sensor by means of the field transmitter;
   wherein the magnetic sensor is electronically connected to the motor, preferably connected to an electronic circuit that controls the activation and deactivation of the motor, being able to be connected through the electronic control of the cylinder, wherein said motor is configured to be deactivated when the magnetic sensor detects a change in the position of the position detection magnet with respect to the magnetic sensor.

The system for detecting rotation of the rotor represents a great advantage over existing electronic cylinders on the market, since in a part of cylinders of this type, the battery constantly supplies energy to the motor until the key is removed, which makes consumption very high. However, by means of the system for detecting rotation, at the moment the rotation of the rotor with respect to the stator is detected, the electrical energy supply is cut off, thereby optimising energy consumption.

The cylinder can be configured in such a way that, when the rotor rotates with respect to the stator body, changing the magnetic field detected by the sensor by a specific value, the motor circuit deactivates the power supply to the motor. This change in the magnetic field is due to the fact that when the rotor rotates, the magnet is no longer aligned with the field transmitter and the magnetic sensor, thus modifying the transmission of the field received by said magnetic sensor.

Preferably, the magnetic sensor, the field transmitter and the position detection magnet are initially aligned (with an angle of 0° between them), and when the rotor rotates with respect to the stator body, when the key is turned, opening the electronic cylinder for opening the access, they are misaligned, being inclined at an angle, for example, with respect to the vertical. At this time, the magnetic sensor detects this displacement, or rotation, cutting off the electrical power supply to the motor, thereby improving the energy efficiency of the cylinder.

The electronic key can be a peripheral that includes a control with the opening logic, so that it can be electronically connected to the cylinder to unlock it.

In one embodiment, the clutch mechanism in turn comprises at least one locking ball and one rocker arm connected to the motor, said rocker arm being configured to rotate on about itself, when the motor is actionable, between a locked position and an unlocked position, wherein said rocker arm comprises at least one radial opening.

A rocker arm is understood to be a part in the form of a disc, bar or rod, which is mobile by being able to rotate around an axis, in this case from the axis defined by the electronic cylinder, and which serves to release or lock the rotation of the rotor with respect to the stator body.

In this embodiment, the rotor is configured to rotate with respect to the stator body and comprises a rotor supplement comprising a first section comprising an inner opening in which the rocker arm is inserted with clearance into said opening; wherein said first section is inserted externally, with clearance and concentrically, into an inner cavity of the stator body of the electronic cylinder; and at least one radial through hole, preferably also located in the first section of the rotor supplement, wherein at least one locking ball is inserted with clearance.

The fact that the rocker arm is inserted with clearance into the inner opening of the rotor supplement means that said rocker arm can rotate concentrically with respect to said rotor supplement, remaining in the inner opening thereof, without transferring the rotation to the rotor supplement. Similarly, the fact that the first section of the rotor supplement is inserted with clearance into an inner cavity of the stator body means that said rotor supplement can rotate with respect to the stator body while maintaining concentricity.

The radial through hole in which the locking ball is located can be a through bore, oriented in a radial direction of the rotor supplement, with a diameter large enough to house the locking ball, allowing it to move radially, throughout its interior, as a result of the play it has.

Also in this embodiment, the inner cavity of the stator body, in which the first section of the rotor supplement is located, comprises a concavity in which a part of the locking ball is located when the rotor supplement is in a closed position of the electronic cylinder. Said concavity can comprise straight planes or curved surfaces, which facilitate the locking of the rotor supplement with respect to the stator body, as well as the sliding of the locking ball through same.

In one embodiment, the rocker arm is in the locked position when the radial opening is radially misaligned with respect to the radial through hole of the rotor supplement and is in the unlocked position when the radial opening is radially aligned with the radial through hole of the rotor supplement.

Thus, in one embodiment, with the rocker arm in the unlocked position, the locking ball is configured to be removed from the concavity of the stator body and to be inserted in the radial opening of the rocker arm, remaining inside the radial through hole of the rotor supplement, when the rotor rotates with respect to the stator body. Preferably, said rotation is due to the rotation of the key inserted in the electronic cylinder.

Moreover, with the rocker arm in the locked position, the locking ball is partially inserted in the concavity of the stator body and is configured to lock the rotation of the rotor with respect to said stator body, since it could not be inserted in the radial opening of the rocker arm. Given that said ball has a diameter greater than the radial space of the hole of the rotor supplement in which it is inserted, it is necessary to leave a part of said ball on the outside of said hole, either on the interior or on the exterior, that is, either in the concavity of the stator body or in the radial opening of the rocker arm. That is, if the rocker arm does not allow the insertion of the ball in the radial opening due to its orientation, it would prevent the rotation of the rotor and, therefore, the opening of the lock.

In this way, if, when inserted in the electronic cylinder, the electronic key does not have an authorisation code, the cylinder electronics would not activate the motor and, therefore, would not rotate the rocker arm, maintaining the locking of the rotor. If the key had the authorisation code, the motor would rotate the rocker arm, which would be in an unlocked position, allowing the rotation of the rotor with respect to the stator body.

In one embodiment, the rotor comprises, in addition to the rotor supplement, a rotor head comprising the motor and the clutch mechanism, wherein the rotor head and the rotor supplement are connected. That is, they share the same integral rotation. In this way, with the rocker arm in the unlocked position, the rotation of the rotor with respect to the stator body to open the electronic cylinder represents the rotation of not only the rotor supplement, but also of the motor and of the components of the clutch mechanism in an integral manner, in their entirety, with respect to the stator body. This means that a part of the clutch mechanism or the motor does not rotate, but rather the assembly does.

In one embodiment, the rotor supplement comprises a second section connected to a cam, wherein said cam is configured to rotate, with respect to the stator body, integrally with the rotation of the rotor supplement. That is, said cam rotates when the rotor rotates with respect to the stator body.

In one embodiment, the rotation of the rotor with respect to the stator body is integral with the rotation of the electronic key with respect to the stator body, when said electronic key is inserted in the electronic cylinder.

In this embodiment, with the rocker arm in the unlocked position, rotating the key rotates the rotor and the locking ball can move radially, entering the radial opening of the rocker arm, thus allowing the rotor supplement to continue rotating, thus moving the cam and allowing the opening of the lock. That is, with this embodiment, the rotational movement of the rotor is generated by the user who carries and rotates the key.

In one embodiment, the motor can be actionable or actuated by the electronic key when said key is inserted in or connected to the electronic cylinder, said key being a key authorised for opening. That is, the motor requires the authorised key to be inserted or connected in the cylinder for said actuation to take place, directing the electrical consumption of the cylinder in the rotation of the motor to rotate the rocker arm.

In one embodiment, the clutch mechanism comprises an actuator disc connected to the motor and the rocker arm, configured to transfer the rotation of the shaft of said motor to the rocker arm when the motor is actionable or actuated, that is, to transmit the torque from the motor to the rocker arm; and a recovery spring, preferably a torsion spring assembled on the actuator disc, configured to rotate said actuator disc in a direction of rotation opposite the rotation of the motor, and to rotate the rocker arm from the unlocked position to the locked position. That is, with this embodiment, the motor can rotate the rocker arm from the locked to the unlocked position by means of the actuator disc by rotating the shaft of said motor when it is activated, but it is the spring that performs the rotation in the opposite direction when a load is exerted on the same actuator disc.

The connection between the motor shaft and the actuator disc is solid, that is, the actuator disc rotates about itself when the motor is actuated, while the connection between the actuator disc and the rocker arm is preferably tongue and groove, the actuator disc comprising projections that can be assembled in grooves on the rocker arm. As the actuator disc and the recovery spring are comprised in the clutch mechanism, and the clutch mechanism is in the head of the rotor, when the cylinder lock is opened, both the actuator disc and the recovery spring rotate integrally with the motor body, the rotor supplement and the rocker arm, with respect to the stator body, which remains fixed.

The recovery of the rocker arm position is due to the rotation energy accumulated in the recovery spring when the actuator disc is rotated by the motor. For this reason, once the rotation of the rotor is carried out, as indicated in one of the previous embodiments, by rotating the key, the motor is disconnected and the rocker arm can recover its locked state by being rotated in the opposite direction due to the effect of the spring. In this way, before the rocker arm is placed in its initial locked position, the locking ball is projected radially towards the concavity of the stator body. That is, with this embodiment, the recovery movement of the rocker arm is not carried out by the motor, but rather by the spring, thus reducing the electrical consumption of the cylinder.

In one embodiment, the clutch mechanism comprises two locking balls, each inserted in one of two radial through holes of the rotor supplement, wherein the rocker arm comprises two radial openings, one for each locking ball; and wherein the inner cavity of the stator body in which the first section of the rotor supplement is located comprises two concavities wherein a part of one of the two blocking balls is located in a tight manner in each one of them.

With this embodiment, the locking of the rotor with respect to the stator is greater and, therefore, the cylinder is more robust and less susceptible to undesired tampering. Preferably, the locking balls are diametrically aligned, that is, they face each other with respect to the axis that defines the rocker arm.

In one embodiment, the electronic cylinder comprises at least one recovery magnet attached to the stator body configured to attract the locking ball, made of a magnetic material, to the concavity of the inner cavity of said stator body. In other embodiments, instead of a magnet, gravity can be used as a means to position the ball in the concavity, locking the rotor with respect to the stator.

In one embodiment, the electronic cylinder comprises an electronic control connected to the motor and connectable to the electronic key when said key is inserted or connected in the electronic cylinder. This electronic control verifies that the inserted key is authorised, controls the activation of the motor and also performs control over the use of the cylinder.

In one embodiment, the electronic cylinder comprises a pin locking, key insertion and key removal mechanism, wherein said mechanism comprises at least:
an upper pin connected to the stator body of the lock by means of a compression spring, wherein said compression spring and the upper pin are housed in a hole in the stator body;
a lower pin which, in a position for inserting and removing the key, rests on the upper pin; wherein said lower pin is movable in the direction of the hole in the stator body in which the upper pin is located when said key is inserted in or removed from the electric cylinder.

This locking mechanism allows the key to be inserted in and removed from the cylinder in certain positions, said pin system being common in mechanical locks.

Likewise, the system for detecting rotation of the rotor is suitable for electronic locks in which it is necessary to rotate the rotor more than 360°, with respect to the stator body, to open them, known as a multi-turn lock. Locks of this type have the drawback of having to unlock the rotor every time the rotor rotates a full turn, for which it is necessary to remove and re-insert the electronic cylinder key.

However, with the system for detecting rotation of the rotor, in the case of a multi-turn lock, the magnetic sensor can be configured to detect that the rotor has rotated 360° and is close to passing through the 0° position again (that is, making a full turn with respect to the stator body) activating the motor again to move it from the locked to the unlocked position and thus make operation more comfortable for the user since it is not necessary to remove the key.

Specifically, in this embodiment, the motor can be configured to be deactivated when the magnetic sensor detects a decrease in the magnetic field emitted by the position detection magnet; and the motor is configured to be activated when the magnetic sensor detects an increase in the magnetic field emitted by the position detection magnet.

In addition to the electronic cylinder, the invention also comprises the electronic lock comprising an electronic key and an electronic cylinder such as the one described, defined in any of the preceding embodiments, wherein the electronic key comprises a battery that provides an electrical power supply to the motor of the electronic cylinder.

With this embodiment, the battery of the key supplies the only electrical energy needed for the motor of the cylinder to move the rocker arm to its unlocked position. If, after a programmed time, the rotor has not been rotated, that is, if the key has been inserted, the signal has been sent to the motor to rotate the rocker arm, but the rotor has not rotated with respect to the stator body, such as, for example, by rotating the key, the cylinder can be configured for the energy to be disconnected and the rocker arm to return to its locked position. Energy is thereby optimised and inappropriate and/or malicious use prevented.

In one embodiment of the electronic lock, the electronic cylinder comprises electrical connectors configured to be connected to electrical connectors of the electronic key.

By means of this embodiment, when the key is inserted in the cylinder, both connector elements are put in communication, and it is certified that the key code is authorised to perform the opening. If the code is authorised, the cylinder electronics send the order to the motor to start moving, moving the rocker arm, making it rotate, until it is in its unlocked position.

### BRIEF DESCRIPTION OF THE DRAWINGS

The terms Fig., FIG., Figs., FIGS., Figure, and Figures are used interchangeably to refer to the corresponding figures in the drawings.

With the intention of helping to better understand the system developed and in relation to a practical and preferred exemplary embodiment thereof, a series of drawings is offered where the following has been represented:

FIG. 1A shows a perspective view of the electronic cylinder inserted by an electronic key.

FIG. 1B shows the same perspective view of the electronic cylinder inserted by an electronic key of FIG. 1A, cut in half along a longitudinal plane, allowing the components located inside the stator body to be observed.

FIG. 2A shows an elevational view of the electronic cylinder inserted by an electronic key.

FIG. 2B shows a profile view of the electronic cylinder inserted by an electronic key, said view being used to show section planes (AA and BB) depicted in FIGS. 2C and 2E.

FIG. 2C shows an elevational view, cut along a longitudinal plane, indicated with the reference A-A of FIG. 2B, wherein the depiction of the key is shown interrupted on the left, and wherein the components inside the electronic cylinder can be seen.

FIG. 2D shows a detailed view of FIG. 2C, depicted with reference “C” in which the assembly of the rocker arm, the actuator disc, the motor, the rotor supplement and the recovery spring can be seen enlarged.

FIG. 2E shows a plan view, interrupted in a lower part, cut by a transverse plane B-B indicated in FIG. 2B, of the electronic cylinder.

FIG. 2F shows a detailed view of FIG. 2E, depicted with reference “D”, wherein the assembly between the balls, the magnets, the rocker arm, the actuator disc, the recovery spring, the motor and the rotor supplement can be seen enlarged and from a plan perspective.

FIG. 3 shows an exploded perspective view of the rotor in which the rotor head, which comprises the actuator disc and the rocker arm, the rotor supplement and the locking balls can be seen.

FIG. 4 shows a perspective view of the electronic cylinder, wherein the assembly formed by the rotor supplement, the rocker arm, the cam, the balls and the magnets are assembled in a mounted assembly, moved with respect to the stator body.

FIG. 5 shows an elevational view of the electronic cylinder with the electronic key inserted, said key being depicted in an interrupted form. Said view shows the plane of section with which FIGS. 6A-6D have been depicted, identified with reference E-E.

FIGS. 6A-6D show the different positions of the rocker arm and the rotor supplement with respect to the stator body.

Thus, FIG. 6A shows the rocker arm in a locked state, with the radial opening of the rocker arm misaligned with the radial through hole of the rotor supplement, the cam being in the closed position.

FIG. 6B shows the rocker arm in the unlocked state, with the radial opening aligned with the radial through hole of the rotor supplement, the cam being in the horizontal position, like the holes of the rotor supplement.

FIG. 6C shows the rocker arm in the unlocked state, with the radial opening aligned with the radial through hole of the rotor supplement, with the rotor supplement slightly inclined with respect to the stator body, and the cam in a position inclined the same degrees that the rotor has been rotated with respect to the stator body, according to FIG. 6B, as said cam and rotor share the same rotation.

FIG. 6D shows the rocker arm in the unlocked state, with the rotor supplement more inclined with respect to the stator body, and the cam in a more inclined position, and the same degrees that the rotor has been rotated with respect to the stator body, than it was in FIG. 6C.

FIG. 7A shows an elevational view of the electronic cylinder with the electronic key inserted, said key being depicted in an interrupted form. Said view depicts the plane of section identified with reference F-F.

FIG. 7B shows a profile view, sectioned by a lateral plane of section, shown with reference F-F in FIG. 7A.

FIG. 7C shows a detail of the system for detecting rotation of the rotor, identified with reference “G” shown in FIG. 7B, wherein the magnet, the transmitter and the magnetic sensor are aligned.

FIG. 7D also shows a detail of the system for detecting rotation of the rotor, identified with reference “G” shown in FIG. 7B, wherein the magnet and the magnetic sensor are misaligned.

A list of the references used in the figures is provided below:
(1) Rotor
(2) Stator body
(2.1) Concavity
(3) Locking ball
(4) Recovery Magnet
(5) Rocker arm
(5.1) Radial opening
(6) Position detection magnet
(7) Field transmitter
(8) Magnetic sensor
(9) Electronic key
(10) Compression spring
(11) Rotor Head
(12) Actuator disc
(13) Recovery spring
(14) Motor
(15) Rotor Supplement
(15.1) Hole
(16) Cam
(17) Upper pin
(18) Lower pin

### DESCRIPTION OF THE INVENTION

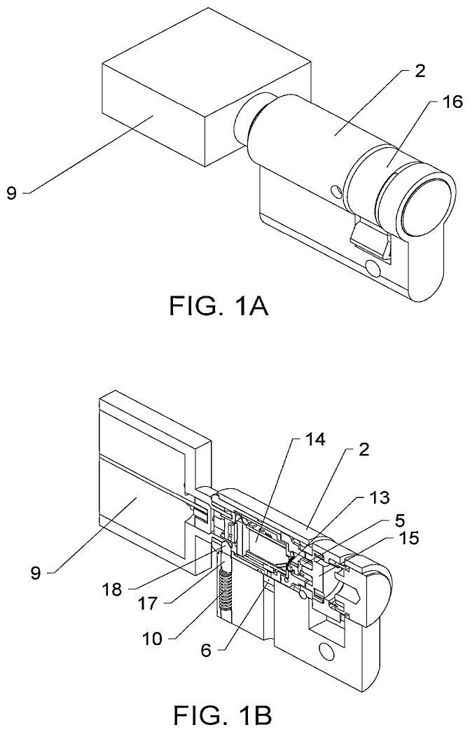

As can be seen in the figures, especially in FIGS. 1A and 1B, the invention consists of an electronic cylinder that can be actuated and inserted by an electronic key (9).

In said FIGS. 1A-1B an electronic key (9) can be seen inserted in one of the front sides of the electronic cylinder, said side being normally visible when the cylinder is mounted on a door or access.

This electronic cylinder, shown in the figures, has the usual external appearance of lock cylinders on the market, whether mechanical or electronic, but it only has an opening through which the electronic key (9) can be inserted to open it.

The operation of the electronic cylinder consists of, with said cylinder being closed when the cam (16) is rotated with respect to the stator body (2) acting as a stop, or connected to a case or pin that is embedded in a hole or stop of a frame of a door, that is, with the lock in which the cylinder is located closed, inserting the electronic key (9) in one end of said cylinder to open same.

The electronic cylinder comprises a rotor (1) which in turn comprises a rotor head (11) and a rotor supplement (15). The motor (14), an actuator disc (12), a rocker arm (5) together with two locking balls (3) and a recovery spring (13) are installed in the rotor head (11).

By inserting said electronic key (9) in the electronic cylinder, the connector of the key (9) connects with electronic connectors of the cylinder, which send a signal to an electronic control of the cylinder, connected to a motor (14), actuating said motor (14). The electrical energy needed to actuate the motor (14) comes from the electronic key (9) which comprises the battery where the electrical energy needed to rotate the motor (14) is stored.

When the motor (14) is activated, it rotates the actuator disc (12) to which it is connected through the shaft of the motor (14) about itself. This actuator disc (12) transfers the rotation, that is, the torque provided by the motor (14) to the rocker arm (5), which is initially in the locked position, as shown in FIG. 6A, rotating it to an unlocked position, as shown in FIG. 6B.

Once said rocker arm (5) has been rotated to an unlocked position, the user can rotate the electronic key (9) that is inserted in the electronic cylinder, rotating with it the rotor (1) completely with respect to the stator body (2), said rotor (1) being attached to the cam (16) of the cylinder by means of the rotor supplement (15), opening the lock, as shown in FIGS. 6C and 6D.

The locking and unlocking of the rocker arm (5) is determined by the clutch mechanism of the cylinder. This mechanism comprises, from the inside out and concentrically, in addition to the rocker arm (5), two locking balls (3) inserted in two radial facing holes of the rotor supplement (15), the rotor supplement (15), two recovery magnets (4) located in a fixed manner, attached to the stator body (2), as well as the stator body (2) itself of the cylinder. That is, an arrangement like the one shown in FIGS. 6A-6D, wherein the rocker arm (5) is located in an inner opening of the rotor supplement (15), with a clearance between them that allows independent rotation between them, and the rotor supplement (15) is located in a cavity inside the stator body (2), also with clearance.

The operation of this mechanism is explained from this sequence of FIGS. 6A-6D, in such a way that in FIG. 6A, the rocker arm (5) is in the locked position, since the two radial openings (5.1) that it comprises, and which are located on the perimeter of said rocker arm (5), are not aligned with the two holes (15.1) of the rotor supplement (15) in which the locking balls (3) are located.

Once the rocker arm (5) goes from the locked to the unlocked position, that is, it rotates about itself, going from a position shown in FIG. 6A to that shown in FIG. 6B, the electronic key (9) inserted in the cylinder can be rotated, rotating the rotor (1) with it. When said rotor (1) rotates, the locking balls (3), which in the closed position of the lock, are each inserted in the holes (15.1) of the rotor supplement (15) and partially inserted in concavities (2.1) of the stator body (2) due to the attraction exerted by the recovery magnets (4), which are adjacent to said concavities (2.1), can be inserted, also partially, in the radial openings (5.1) of the rocker arm (5), as shown in FIG. 6C, being removed from the concavities (2.1) due to the effect of the geometry thereof, allowing the joint rotation of the rocker arm (5) and the rotor supplement (15) with respect to the stator body (2).

If the rocker arm (5) had not been rotated by the actuation of the motor (14), the locking balls (3) could not be inserted in the radial openings (5.1) so they would not act as a stop between the stator body (2) and the rotor supplement (15), preventing rotation of the rotor (1).

Once the electronic key (9) is rotated and the rotor (1) has rotated with respect to the stator body (2), rotating the cam (16) and therefore opening the lock, the electronic key (9) can be removed from the cylinder in the same position in which it was inserted, that is, for example horizontally or vertically, like most locks, as a result of a pin mechanism comprised therein, leaving the rotor supplement (15) in a position as shown in FIGS. 6A and 6B.

In order for the rocker arm (5) to rotate to a locked position once the cylinder has been opened, the clutch mechanism also comprises a recovery spring (13) connected to the actuator disc (12), which accumulates energy due to the rotation of the motor (14) when it rotates the rocker arm (5) to the unlocked position, allowing the energy accumulated during the deformation of said spring (13) to be used to rotate the rocker arm (5) in the opposite direction, to the locked position, as shown in FIG. 6A.

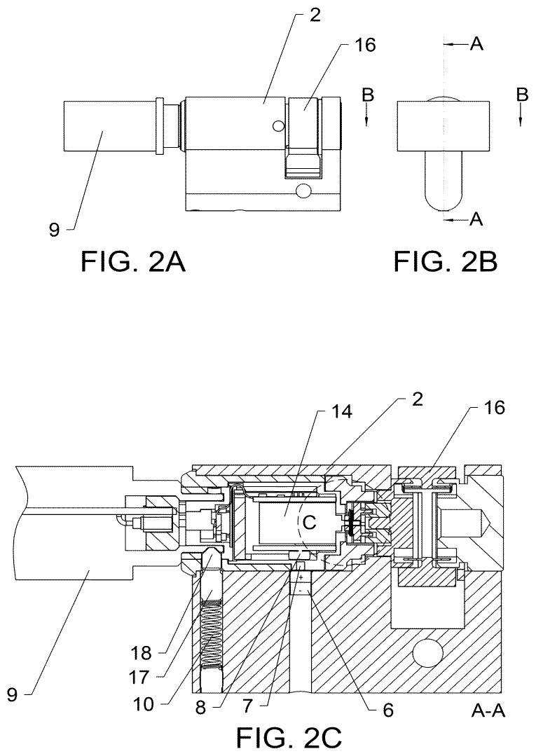

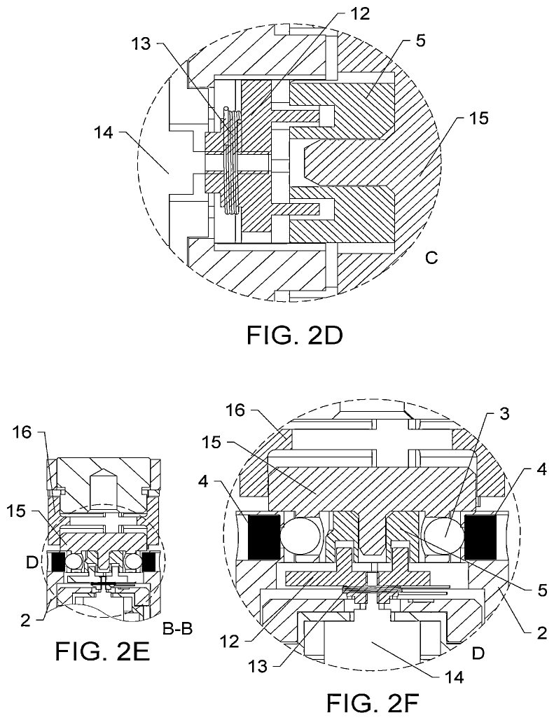

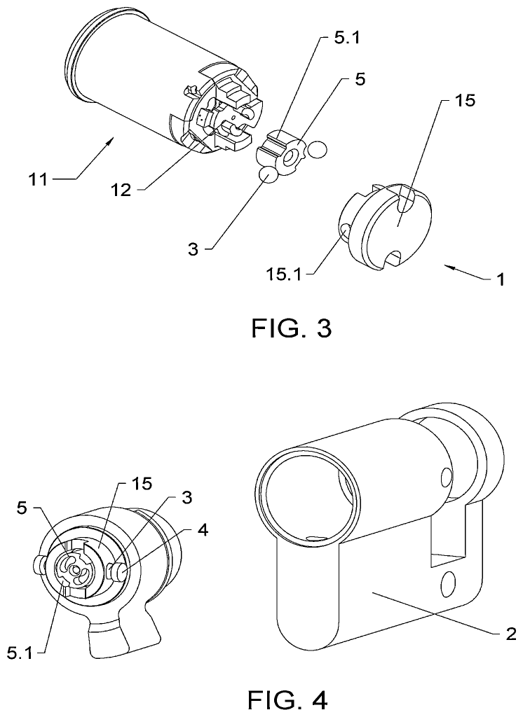

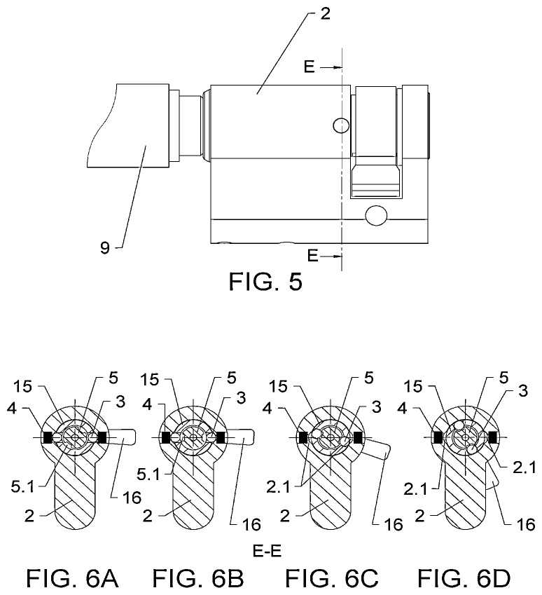

The pin mechanism comprises an upper pin (17) connected to the stator body (2) of the lock by means of a compression spring (10), and a lower pin (18) resting on a surface of said upper pin (17). When the electronic key (9) is inserted in the electronic cylinder, the pins (17, 18) move inwards, in the direction of the bore in which the compression spring (10) is located, the separation between said pins (17, 18) being located at an exact height that allows the rotation of the key (9) with respect to the stator body (2). This arrangement is clearly shown in FIG. 2C, wherein the plane that separates the two pins (17, 18) coincides with the plane that separates the rotor head (11) from the stator body (2).

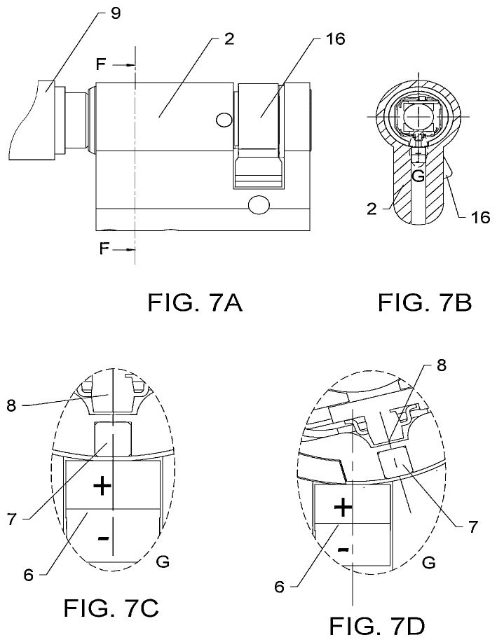

A fundamental part of the preferred invention can be seen in FIGS. 7B-7D, wherein it is shown that the cylinder also comprises a system for detecting rotation of the rotor (1) comprising a position detection magnet (6) located in the stator body (2), that is, it is immobile with respect to the rotation of the rotor (1), a field transmitter (7) comprised in the rotor head (11), sharing rotation with it, and a magnetic sensor (8), also located in the rotor head (11), configured to detect the magnetic field of the position detection magnet (6), channelled through the field transmitter (7).

This system for detecting rotation allows knowing when the rotor (1) has rotated with respect to the stator body (2), in such a way that it allows cutting off the electrical power supply from the battery of the electronic key (9) to the motor (14) when the rocker arm (5) has been unlocked, thereby optimising electrical consumption.

In the event that the electronic cylinder is of the “multi-turn” type, that is, it requires the rotor (1) to rotate with respect to the stator body (2) more than one turn to the opening means (door) to open or close, this system for detecting rotation makes it possible to avoid having to remove and insert the electronic key (9) for each completed turn, so that the rocker arm (5) recovers the unlocked position shown in FIG. 6B.

For this, the magnetic sensor (8) can be configured to detect that the rotor (1) has rotated 360° and is close to passing through the 0° position (that is, to detect that the rotor (1) makes a full turn with respect to the stator body (2)) activating the motor (14) again to move it from the locked to the unlocked position and thus make operation more comfortable for the user, since it is not necessary to remove and insert the key again to unlock the rocker arm (5).

In this embodiment, the motor (14) can be configured to be deactivated when the magnetic sensor (8) detects a decrease in the magnetic field emitted by the position detection magnet (6); and the motor (14) is configured to be activated when the magnetic sensor (8) detects an increase in the magnetic field emitted by the position detection magnet (6).

That is, both the recovery spring (13) and this system for detecting rotation, as well as the arrangement of the previously defined clutch mechanism, together allow the electrical consumption of the cylinder to be optimised, maintaining the robustness capacity of said cylinder.

1. An electronic cylinder-insertable and actionable by an electronic key, wherein the electronic cylinder comprises:
a stator body;
a motor actionable by the electronic key;
a rotor configured to rotate with respect to the stator body;
a clutch mechanism configured to lock and unlock the rotation of the rotor with respect to the stator body by actuating the motor; and
a system for detecting rotation of the rotor with respect to the stator body, wherein said system is configured to deactivate the motor when the rotor rotates with respect to the stator body.

2. The electronic cylinder according to claim 1, wherein the system for detecting rotation of the rotor comprises:
a position detection magnet located in the stator body;
a field transmitter-located in the rotor; and
a magnetic sensor located in the rotor, configured to detect the magnetic field emitted by the position detection magnet and channelled to the magnetic sensor by means of the field transmitter;
wherein the magnetic sensor is electronically connected to the motor; wherein said motor is configured to be deactivated when the magnetic sensor detects a change in the position of the position detection magnet with respect to the magnetic sensor.

3. The electronic cylinder according to claim 2, wherein the system for detecting rotation of the rotor is configured to deactivate the motor when the magnetic sensor detects a decrease in the magnetic field emitted by the position detection magnet; and to activate said motor when the magnetic sensor detects an increase in the magnetic field emitted by the position detection magnet.

4. The electronic cylinder according to claim 1, wherein the clutch mechanism comprises:
a rocker arm connected to the motor, configured to rotate between a locked position and an unlocked position, wherein said rocker arm comprises at least one radial opening; and
at least one locking ball;
wherein the rotor comprises a rotor supplement comprising:
a first section comprising an inner opening, wherein the rocker arm is inserted with clearance into said opening; wherein said first section is inserted externally, with clearance, and concentrically, into an inner cavity of the stator body of the electronic cylinder; and
a radial through hole wherein the locking ball is inserted with clearance;
wherein the inner cavity of the stator body, in which the first section of the rotor supplement is located, comprises at least one concavity fly in which a part of the at least one locking ball is located when the rotor supplement is in a closed position of the electronic cylinder.

5. The electronic cylinder according to claim 4, wherein the rocker arm is in the locked position when the radial opening is radially misaligned with respect to the radial through hole of the rotor supplement and is in the unlocked position when the radial opening is radially aligned with the radial through hole of the rotor supplement.

6. The electronic cylinder according to claim 4, wherein with the rocker arm in the unlocked position, the locking ball is configured to be removed from the concavity of the stator body and to be inserted in the radial opening of the rocker arm, when the rotor rotates with respect to the stator body; and
wherein with the rocker arm in the locked position, the locking ball is partially inserted in the concavity of the stator body, configured to lock the rotation of the rotor with respect to the stator body.

7. The electronic cylinder according to claim 4, wherein the rotor comprises a rotor head comprising the motor and the clutch mechanism, wherein the rotor head and the rotor supplement are connected.

8. The electronic cylinder according to claim 4, where the rotor supplement comprises a second section attached to a cam, wherein said cam is configured to rotate, with respect to the stator body, integrally with the rotation of the rotor supplement.

9. The electronic cylinder according to claim 4, wherein the clutch mechanism comprises:
an actuator disk, connected to the motor and to the rocker arm, configured to transfer the rotation of the shaft of said motor to the rocker arm when the motor is actuated; and
a recovery spring assembled on the actuator disc, configured to rotate said actuator disc in a direction of rotation opposite the rotation of the motor, and to rotate the rocker arm from the unlocked position to the locked position.

10. The electronic cylinder according to claim 4, wherein the clutch mechanism comprises two locking balls, each inserted in one of two radial through holes of the rotor supplement, wherein the rocker arm comprises two radial openings, one for each locking ball; and wherein the inner cavity of the stator body in which the first section of the rotor supplement is located comprises two concavities wherein a part of one of the two locking balls is located in a tight manner in each one of them.

11. The electronic cylinder according to claim 4, comprising at least one recovery magnet attached to the stator body configured to attract the locking ball, made of a magnetic material, to the concavity of the inner cavity of said stator body.

12. The electronic cylinder according to claim 1, comprising a pin locking, key insertion and key removal mechanism, wherein said mechanism comprises at least:
an upper pin connected to the stator body of the lock by means of a compression spring, wherein said compression spring and the upper pin are housed in a hole in the stator body;
a lower pin which, in a position for inserting and removing the key, rests on the upper pin; wherein said lower pin is movable in the direction of the hole in the stator body in which the upper pin is located when said key is inserted in or removed from the electric cylinder.
